(19) United States
(12) Patent Application Publication
(10) Pub. No.: US 2008/0187735 A1
(43) Pub. Date: Aug. 7, 2008

(54) Non-Woven Fabric and Food Casing Which is Produced Therefrom and Which is Based on Cellulose Hydrate

(76) Inventors: Klaus-Dieter Hammer, Mainz (DE); Herbert Gord, Ingelheim (DE); Walter Lutz, Budenheim (DE)

Correspondence Address: PROPAT, L.L.C., 425-C SOUTH SHARON AMITY ROAD, CHARLOTTE, NC, 28211-2841, US

(21) Appl. No.: 11/718,422

(22) PCT Filed: Nov. 2, 2005
(86) PCT No.: PCT/EP05/11685

§ 371 Date: May 2, 2007

(30) Foreign Application Priority Data
Nov. 5, 2004 (DE) 10 2004 053 412.8

(51) Int. Cl. A22C 13/00; C08B 15/00

(52) U.S. Cl. 428/219; 442/327; 162/164.1; 428/34.8

(57) ABSTRACT

The invention relates to a viscose and resin-bound non-woven fabric based on cellulose fibres, which is cross-linked to a urea methoylol having a low-molecular weight and which does not react with itself, which has, preferably, a cyclic structure. The urea methylol is preferably, dimethylol-ethylene-urea, substituted, optionally, in 4- and/or 5-positions, more preferably, dimethylol-dihydroxy-ethylene-urea, a 1,3-bis-hydroxymethyl-5-(C1-C6)alkyl-tetrahydro-1H-[1,3,5]triazine-2-one, preferably, dimethylol-ethyl-triazinone, dimethylol-propylene urea, dimethylol-hydroxy-propylene urea or tetramethylol-acetylene urea. The humidity-resistant non-woven fabric can be used as a reinforcer in food casings based on regenerated or precipitated cellulose, in particular in cellulose fibre skins.

The invention relates to a nonwoven which is bonded in such a manner to give wet strength and alkali resistance and is based on cellulosic fibers, and also to a process for production thereof. It further relates to a food casing which is based on cellulose hydrate and contains the nonwoven fabric as reinforcing material. The food casing is intended, in particular, as artificial sausage casing.

Tubular casings based on cellulose hydrate having a reinforcement of a nonwoven fabric, which are also termed cellulose fiber skins, are long proven. In the production of the cellulose fiber skins, generally first a nonwoven fabric or fibrous paper, preferably a hemp fiber paper, is shaped to form a tube. The tube is then charged with viscose from the outside, from the inside or from both sides. The tube thereafter runs through an acidic spinning bath in which the viscose is coagulated and regenerated to cellulose. The fibrous paper tube is finally completely covered on one or both sides with a layer of cellulose hydrate.

The fibrous paper need not necessarily be shaped to form a tube. It is also known to coat a fibrous paper with viscose in the flat state and then to coagulate the viscose in the spinning and wash baths and finally to regenerate it to cellulose hydrate. The cellulose hydrate-coated fibrous paper can then if appropriate be shaped to form a tube, the overlapping edges of which, to form a permanently strong seam, are stuck, sealed or sewed to one another. Tubular fiber-reinforced cellulose casings with or without a seam are used to a great extent as artificial sausage casings.

Various possibilities are disclosed in the prior art as to how a nonwoven fabric or fibrous paper can be made to have wet strength and alkali resistance. According to U.S. Pat. No. 3,135,613, a hemp fiber paper is impregnated with a dilute viscose solution, the viscose solution containing a cellulose xanthogenate fraction which is equivalent to 0.5 to 3% by weight cellulose. The cellulose xanthogenate is then regenerated to cellulose hydrate in an acidic spinning bath. The impregnated nonwoven fabric is subsequently washed and dried. The coating of regenerated cellulose resulting on the hemp fibers is so thin that the porous structure of the paper is retained. It increases especially the wet strength of the paper. A disadvantage of this viscose-bonded fibrous paper is the fact that the coating of regenerated cellulose is not sufficiently alkali resistant and stable to hydrolysis. In the production of fiber-reinforced cellulose casings, the fibrous paper is coated with viscose solution which as is known is strongly alkaline. In the action of the coating viscose on the paper, the cellulose hydrate already present as binding agent for the paper fibers is therefore in part redissolved. The paper fibers are then no longer sufficiently strongly bonded to one another. This also makes itself noticeable in the finished fiber-reinforced cellulose casings. They have a tendency to burst even at a relatively low internal pressure.

In order to overcome this disadvantage, therefore, fibrous papers have been developed which were given wet strength in another manner. For instance, GB 1 091 105 discloses a hemp fiber paper which contains an alkali curing synthetic resin, for example a polymeric reaction product of epichlorohydrin with polyamide, or a polyethyleneimine resin. For production of a fiber-reinforced cellulose food casing, this paper is shaped to form a tube in the known manner and coated with viscose. The cellulose is then regenerated from the viscose as is customary.

In U.S. Pat. No. 3,484,256, this concept is further developed. The fibrous paper is now bonded with a mixture of a cationic, heat-curing resin and an ionic or nonionic polyacrylamide resin. The rupture resistance of the fiber-reinforced cellulose hydrate sausage casings produced using this fibrous paper, however, is not always satisfactory for certain sausage types.

DE-A 10 2004 051 298, which was unpublished at the priority date of the present application, discloses a nonwoven fabric having wet strength, preferably a fibrous paper, which in addition to fibers of cellulosic material additionally contains thermoplastic fibers which are firmly welded together at their crossing points. The fibers of cellulosic material are preferably hemp fibers, whereas the thermoplastic fibers are preferably those made of polypropylene, polyester or polyamide. The fibers are bonded under the action of pressure and/or heat, in particular using heated calender roll pairs which is complex in terms of apparatus. The nonwoven fabric or fibrous paper is used in particular as reinforcement in food casings based on regenerated cellulose, especially in artificial sausage casings based on cellulose hydrate.

The object therefore is still to provide a fibrous paper or nonwoven fabric which has a high wet strength and retains this even after the action of alkaline media such as the viscose used for coating. It must be particularly suitable as fiber reinforcement in food casings based on cellulose hydrate. The casings produced therewith must be strong and extensible. In addition, they must have sufficient swellability and good shrink behavior. The nonwoven fabric, in addition, must be environmentally friendly and be as simple as possible to produce. The cellulose fiber skins produced using the nonwoven fabric to be developed must be equally strong and extensible, they must have high swellability and a good shrink behavior.

The object has been achieved by a nonwoven fabric or fibrous paper which is bonded with synthetic resin and dilute viscose. The decisive improvement is the fact that the cellulose hydrate from the dilute viscose is treated with a low-molecular-weight, in particular cyclic, methylol urea. The cyclic methylol urea reacts with the cellulose and crosslinks it, so that it becomes more resistant to alkali.

The present invention accordingly relates to a viscose- and resin-bonded nonwoven fabric based on cellulosic fibers, characterized in that it is additionally crosslinked by a low-molecular-weight methylol urea. The expression “low-molecular-weight methylol ureas” is to be taken to mean here compounds which contain no more than 3, preferably no more than 2, substituted urea groups of the structure —N(CH₂—OH)—CO—N(CH₂—OH)— or —NH—CO—N(CH₂—OH)₂ and which do not react with one another, that is they are stable as molecules and do not condense.

The low-molecular-weight methylol urea preferably has a cyclic structure. Examples of such methylol ureas are if appropriate 4- and/or 5-substituted 1,3-bis-hydroxymethyltetrahydroimidazol-2-one (=dimethylol ethyleneurea), especially 4,5-dihydroxy-1,3-bishydroxymethyltetrahydroimidazol-2-one (=dimethylol dihydroxy-ethyleneurea), a 1,3-bishydroxymethyl-5-(C1-C6)alkyl-tetrahydro-1H-[1,3,5]triazin-2-one, especially 1,3-bishydroxymethyl-5-ethyltetrahydro-ltf-[1,3,5]triazin-2-one (=dimethylol ethyltriazinone), 1,3-bishydroxy-methyltetrahydro-lff-pyrimidin-2-one dimethylol propyleneurea), 5-hydroxy-1,3-bishydroxymethyltetrahydro-lJf-pyrimidin-2-one (=dimethylol hydroxypropyleneurea) or tetrakishydroxymethyltetrahydro-lif, 3#-imidazo[4,5-d]imidazol-2,5-dione (=tetramethylol acetylenediurea). Such methylol ureas are known and described, for example in DE-A 22 46 829. The nonwoven fabric according to the invention contains about 1 to 12% by weight, preferably about 3 to 6% by weight, of cyclic methylol urea (generally in crosslinked form), based on its dry weight.

The viscose bonding generally proceeds by treating the fibrous paper with a dilute viscose solution. The solution expediently contains about 1.0 to 3.0% by weight, preferably about 1.5 to 2.5% by weight, cellulose in the form of cellulose xanthogenate.

For the resin bonding, preferably use is made of water-soluble cationic resins, in particular polyamine-polyamide-epichlorohydrin resins. However, other resins or glues are also usable, for example urea-formaldehyde resins or urea-melamine-formaldehyde resins.

The resin or resin mixture can be mixed with the aqueous fiber pulp from which the nonwoven fabric is then scooped. It can also be applied to a preexisting nonwoven fabric. In each case, the paper is subsequently dried by warming or heating. In this process the resin and/or the glue crosslinks and in this manner strengthens the nonwoven fabric.

The fibers of cellulosic material are preferably hemp fibers. Instead of, or in addition to, the hemp fibers, other plant cellulosic fibers or plant fibers derived therefrom, in particular chemically modified plant fibers, can be present.

In a particular embodiment, the cellulosic fibers are mixed with fibers of synthetic polymers. Those which may be mentioned are, for example, fibers of polypropylene, polyamide or polyester. However, the fraction of these fibers should not be too high, because otherwise the cellulose regenerated from the coating viscose no longer adheres sufficiently to the fibrous paper in the finished cellulose fiber skin. An expedient fraction is 1 to 20% by weight, preferably 2 to 12% by weight, based on the weight of the cellulosic fibers.

The nonwoven fabric or fibrous paper according to the invention generally has a weight of about 12 to 30 g/m², preferably about 15 to 28 g/m². It exhibits, inter alia, higher wet strength and dry strength than the fibrous papers previously used in which the bonding cellulose is not crosslinked. Especially, it exhibits a higher alkali resistance which is of particular importance in the production of fibrous skins by the viscose process.

The tubular food casings of the invention can be additionally coated or impregnated on the inside and/or outside. Suitable coatings or impregnations are generally known to those skilled in the art. Those which may be mentioned are, in particular, PVDC inner coatings which greatly decrease the permeability of the casing to water vapor and atmospheric oxygen. For the PVDC inner coating, use is made in particular of vinylidene chloride copolymers which have about 60 to 85% by weight of VDC units. In addition, impregnations may be mentioned with which the adhesion of the casing to the food situated therein may be set. Reference is particularly made to what are termed easy peel impregnations which make the casing readily peelable. Finally, the food casing of the invention can also be impregnated with liquid smoke or other aroma substances, flavor substances and/or dyes.

The fibrous paper or nonwoven fabric according to the invention is produced by processes which are in principle familiar to those skilled in the art active in fibrous paper production. In particular the following steps are comprised:
spreading an aqueous pulp which comprises fibers of cellulosic material;
if appropriate mixing the fiber pulp with water-soluble binders, preferably with water-soluble cationic resins, in particular with polyamine-polyamide-epichlorohydrin resins;
depositing the fibers on a screen for formation of a fibrous paper;
drying the fibrous paper;
treating the dry fibrous paper with dilute viscose which additionally contains at least one cyclic methylol urea;
regenerating the viscose to cellulose hydrate in an acidic precipitation bath and
renewed drying.

In a further embodiment of the process, the cyclic methylol urea is not mixed with the viscose, but is present in the subsequent acidic precipitation bath. In addition, the cyclic methylol urea can also be present in a separate treatment bath. However, this embodiment is less preferred.

The food casing of the invention is produced according to processes which are known in principle to those skilled in the art. In these processes the fibrous paper bonded in a manner which is stable to heat and hydrolysis is generally cut into strips of appropriate width which are shaped to form tubes having overlapping longitudinal edges. The tubes are then charged with viscose from the outside, from the inside or from both sides (outer viscosing, inner viscosing or double viscosing). In precipitation and wash baths, the cellulose is regenerated from the viscose. Alternatively, the tubes of the fibrous paper of the invention can also be coated from the outside, from the inside or from both sides with NMMO cellulose solutions. This procedure has the advantage that no acidic precipitation baths are required. In order to modify the properties of the food casings in accordance with preconditions of users, polymeric additives can be added to the viscose or the NMMO-cellulose solution, such as alginic acid or alginates or polyvinylpyrrolidone. Preference is given to additives which make the food casing permanently soft and which cannot be extracted, that is act as primary plasticizers. The casing, instead of, or else in addition to, such primary plasticizers, can also contain secondary (=extractable) plasticizers such as glycerol.

The cellulose fibrous skins of the invention can generally be finally processed in a known manner, in particular they can be compacted in sections to give shirred sticks.

The food casing is suitable especially as artificial sausage casing, for example for raw sausage, such as salami.

The examples hereinafter serve to illustrate the invention. Percentages therein are to be taken to mean percentages by weight, unless stated otherwise or if is clear from the context.

### EXAMPLE 1

Hemp fibers were converted by the conventional process into a highly dilute aqueous paper pulp in which the hemp fiber fraction was 0.1 to 0.2%. To the pulp was added a water-soluble polyamine-polyamide-epichlorohydrin resin. This amount was of a size such that the finished nonwoven fabric contained 2% resin. The pulp was then passed over an incline screen on which the fibers then formed a coarsely structured fibrous paper. The fibrous paper web was passed over heated rollers of a large diameter and dried. The paper, after drying, had a weight of 21 g/m². It was then passed through a vat which contained a mixture of dilute (1% strength) viscose and 5% dimethylol ethyleneurea (®Cassurit RI from Clariant Deutschland GmbH). To regenerate the cellulose from the viscose, the paper web was thereafter passed through an acid bath. Finally, the paper web was dried again and wound up. The fraction of regenerated cellulose was about 1.5%, based on the dry weight of the paper. In the wet state, the paper exhibited a tear strength of 6 to 7 N/mm² (mean in longitudinal and transverse directions) and an elongation at break of 7 to 8%, based on the starting length (mean in longitudinal and transverse directions). After treatment for 10 min with an aqueous 6% strength NaOH solution, the paper had lost only 12 to 16% of its tear strength, whereas a fibrous paper, the regenerated cellulose of which is not crosslinked, generally loses about 24 to 26% tear strength.

The fibrous paper was then cut in a conventional manner into webs of appropriate width which were then shaped into tubes having overlapping longitudinal edges and were coated from the outside with viscose. The fibrous paper was penetrated by the viscose without problem. The cellulose was coagulated and regenerated in the customary manner with precipitation and wash baths. It adhered well to the fibrous paper and did not detach even in the case of mechanical stress. The tube of caliber 75 produced in this manner had a weight of 85 g/m² (at 12% residual moisture and 22% glycerol), exhibited a bursting pressure (wet) of 76.5 kPa, that is 12% above that produced using conventional fibrous paper. The static extension at 21 kPa was 82.5 mm (specification: 80.3 to 83.3 mm).

The casings were shirred without problem to form shirred sticks which could then be stuffed with sausagemeat emulsion on automatic stuffing machines, likewise without problems. Owing to the higher strength, the loss rate due to bursts was significantly lower.

### EXAMPLE 2

Example 1 was repeated with the exception that the resin-bonded fibrous paper had a dry weight of 23.7 g/m². It contained likewise 2% of a polyamine-polyamide-epichlorohydrin resin. The dry paper was passed through a vat which contained a 1% strength viscose solution and subsequently through a further vat which contained a 2% strength aqueous sulfuric acid. In the further vat, the cellulose was coagulated from the viscose and regenerated. The further vat additionally contained 5%, based on the weight of the regenerated cellulose, of dimethylol dihydroxyethyleneurea ((DArkofix NG from Clariant Deutschland GmbH). The fibrous paper was then redried and wound up. In the wet state it had a tear strength of 9 to 9.5 N/mm² (mean in longitudinal and transverse directions) and an elongation at break of 6 to 6.5%. After a treatment with alkali (6% strength aqueous NaOH; 10 min), the paper had lost only 8 to 12% of its wet strength. The elongation at break remained unchanged.

A tube of caliber 90 was shaped from the paper which was then coated with viscose from the outside. After regeneration of the cellulose from the viscose in the conventional spinning and wash baths, the fibrous skin had a weight of 88 g/m² (at 10% residual moisture and 22% glycerol fraction) and had a bursting pressure of 75 kPa. This value was 22% higher than the theoretical value which a casing produced using conventional fibrous paper has. The static extension at 21 kPa was 101 mm (specification: 99 to 102 mm). The casings were extraordinarily stable. They were able to be shirred easily and stuffed with sausagemeat emulsion on automatic stuffing machines. The shrinkage, maturing and peeling behavior of the casing was usual and corresponded to that of a customary fiber skin.

### EXAMPLE 3

In the manner described in example 1, a fibrous paper was produced which had a dry weight of 25.4 g/m². As in example 2, the fibrous paper was first run through a vat which contained a 1% strength viscose solution. Subsequently, it passed through a further vat in which a mixture of 2.5% strength aqueous sulfuric acid and 3%, based on the weight of the cellulose in the viscose, of dimethylol propyleneurea (©Fixapret PH from BASF Aktiengesellschaft) was situated. The paper was dried again and then wound up. It had a tear strength of 9 N/mm² and an elongation at break of 7%. After alkali treatment (6% strength aqueous NaOH; 10 min), the paper had lost only 15% of its wet strength.

An externally viscosed casing produced using the paper of caliber 120 having a weight of 104 g/m² (at 10% residual moisture and 22% glycerol fraction) had a bursting pressure of 64 kPa, that is 18.5% above the theoretical value customary to date. The static extension at 21 kPa was 135 mm (specification: 133 to 137 mm). The casing could be processed without problem.

### EXAMPLE 4

### Comparative Example

A resin- and viscose-bonded hemp fiber paper as described in example 1 having a weight of 17 g/m² in which the cellulose was regenerated from the viscose but was not crosslinked with a methylol urea was shaped to form a tube of caliber 58 having overlapping longitudinal edges. The tube was then coated with viscose from the outside using an annular die. After it had passed through diverse spinning and wash baths, a conventional cellulose fiber skin was obtained therefrom having a weight of 84 g/m², at a water content of 10%. The bursting pressure (wet) of the fibrous skin was 80 kPa.

In the wet state, the paper exhibited a tear strength of 4.8 N/mm² in the longitudinal direction and 5.9 N/mm² in the transverse direction. After the alkali treatment, the paper had a tear strength of 3.6 N/mm² in the longitudinal direction and 4.6 N/mm² in the transverse direction. The loss of tear strength in the longitudinal direction was 24%, and in the transverse direction 21%.

1. A viscose- and resin-bonded nonwoven fabric comprising cellulosic fibers, wherein said nonwoven fabric is crosslinked with a low-molecular-weight methylol urea which does not react with itself.

2. The nonwoven fabric as claimed in claim 1, wherein the low-molecular-weight urea is cyclic methylol urea.

3. The nonwoven fabric as claimed in claim 2, wherein the cyclic methylol urea is an optionally 4- and/or 5-substituted 1,3-bishydroxy-methyltetrahydroimidazol-2-one.

4. The nonwoven fabric as claimed in claim 1, wherein the fraction of the methylol urea is 1 to 12% by weight based on its total dry weight.

5. The nonwoven fabric as claimed in claim 1, wherein the resin is a water-soluble cationic resin.

6. The nonwoven fabric as claimed in claim 1, wherein said fabric has a dry weight of 12 to 30 g/m².

7. A process for producing the nonwoven fabric as claimed in claim 1, said process comprising the following steps:
a) spreading an aqueous pulp which comprises fibers of cellulosic material;
b) optionally mixing the fiber pulp with water-soluble binders;
c) depositing the fibers on a screen for formation of a fibrous paper;
d) drying the fibrous paper;
e) treating the dry fibrous paper with dilute viscose and at least one low-molecular-weight methylol urea which does not react with itself;
f) regenerating the viscose to cellulose hydrate in an acidic precipitation bath and
g) drying the fibrous paper comprising the regenerated cellulose hydrate.

8. The process as claimed in claim 7, wherein the methylol urea is mixed with the dilute viscose.

9. A food casing based on regenerated or precipitated cellulose, wherein said food casing comprises a nonwoven fabric as claimed in claim 1 as reinforcement.

10. The food casing as claimed in claim 9, wherein said food casing is additionally coated or impregnated on the inside and/or outside.

11. The food casing as claimed in claim 9, wherein said food casing is an artificial sausage casing.

12. The nonwoven fabric as claimed in claim 3, wherein the cyclic methylol urea is 4,5-dihydroxy-1,3-bishydroxymethyltetrahydroimidazol-2-one, a 1,3-bishydroxymethyl-5-(C1-C6)alkyltetrahydro-1H-[1,3,5]triazin-2-one, 1,3-bishydroxymethyltetrahydro-1H-pyrimidin-2-one, 5-hydroxy-1,3-bishydroxymethyltetrahydro-1H-pyrimidin-2-one or tetrakishydroxymethyltetrahydro-1H,3H-imidazo[4,5-d]imidazol-2,5-dione.

13. The nonwoven fabric as claimed in claim 12, wherein the cyclic methylol urea is 1,3-bishydroxymethyl-5-ethyltetrahydro-1H-[1,3,5]triazin-2-one.

14. The nonwoven fabric as claimed in claim 5, wherein the resin is a water-soluble-polyamide-epichlorohydrin resin.

15. The nonwoven fabric as claimed in claim 5, wherein the resin is a water-soluble-polyamide-epichlorohydrin resin.

16. The nonwoven fabric as claimed in claim 6, wherein said fabric has a dry weight of 15 to 28 g/m².

17. A process as claimed in claim 7, wherein the water-soluble binder is water-soluble cationic resin.

18. A process as claimed in claim 17, wherein the water-soluble cationic resin is polyamine-polyamide-epichlorohydrin resin.

19. The process as claimed in claim 7, wherein the methylol urea is contained in an acidic precipitation bath.
